(19) United States
(12) Patent Application Publication
(10) Pub. No.: US 2026/0300355 A1
(43) Pub. Date: Oct. 1, 2026

(54) DIALOGUE SYSTEM, DIALOGUE METHOD, AND DIALOGUE PROGRAM

(71) Applicant: NEC Corporation, Tokyo (JP)

(72) Inventor: Yota KOGURE, Tokyo (JP)

(73) Assignee: NEC Corporation, Tokyo (JP)

(21) Appl. No.: 19/565,711

(22) Filed: Mar. 13, 2026

(30) Foreign Application Priority Data
Mar. 27, 2025 (JP) 2025-052819

(51) Int. Cl. G06F 16/334; G06F 40/279; G06F 40/40

(52) U.S. Cl. CPC G06F 16/3347; G06F 40/279; G06F 40/40

(57) ABSTRACT

The search unit performs a vector search, from a database that stores a conversation history including a user input and a response to the user input, for a related history that is the conversation history related to a target user input. The dialogue unit inputs the target user input and the related history retrieved from the database into a large language model and causes the large language model to output a response. The storage unit vectorizes a conversation history including the target user input and the output response and stores the vectorized conversation history in the database.

### CROSS-REFERENCE TO RELATED APPLICATIONS

This application is based upon and claims the benefit of priority from the prior Japanese Patent Application No. 2025-052819, filed Mar. 27, 2025, the entire contents of which are incorporated herein by reference.

### BACKGROUND OF THE INVENTION

The present disclosure relates to a dialogue system, a dialogue method, and a dialogue program using a large language model.

In recent years, generative artificial intelligence technology has rapidly developed and attracted global attention. Generative artificial intelligence includes a large language model that is trained based on a massive amount of text data and has advanced language understanding and generation capabilities.

In dialogue-type generative artificial intelligence, there exists a system that understands context based on a dialogue history and generates a response. For example, Patent Literature 1 describes a response generation support system capable of generating a long response. The system described in Patent Literature 1 divides instruction data created based on request data into a predetermined number of segments and obtains a plurality of response data.

### Prior Art Documents

### Patent Literatures

Patent Literature 1 Unexamined Patent Application Publication No. 2024-160571

### SUMMARY OF THE INVENTION

On the other hand, a large language model may have an upper limit on the number of tokens for each model. The number of tokens affects response performance and usage fees of the large language model. In the system described in Patent Literature 1, the token limitation is avoided by dividing the instruction data and obtaining responses. However, the system described in Patent Literature 1 merely inputs tokens multiple times for each divided instruction data, and thus does not lead to a reduction in the total number of tokens.

Accordingly, an example object of the present disclosure is to provide a dialogue system, a dialogue method, and a dialogue program that can reduce the number of tokens input to a large language model while suppressing performance degradation.

The dialogue system according to the present disclosure includes a search unit that performs a vector search, from a database that stores a conversation history including a user input and a response to the user input, for a related history that is the conversation history related to a target user input, a dialogue unit that inputs the target user input and the related history retrieved from the database into a large language model and causes the large language model to output a response, and a storage unit that vectorizes a conversation history including the target user input and the output response and stores the vectorized conversation history in the database.

The dialogue method according to the present disclosure includes: performing a vector search, from a database that stores a conversation history including a user input and a response to the user input, for a related history that is the conversation history related to a target user input; inputting the target user input and the related history retrieved from the database into a large language model and causing the large language model to output a response; and vectorizing a conversation history including the target user input and the output response and storing the vectorized conversation history in the database.

The dialogue program according to the present disclosure causes a computer to execute a search process of performing a vector search, from a database that stores a conversation history including a user input and a response to the user input, for a related history that is the conversation history related to a target user input, a dialogue process of inputting the target user input and the related history retrieved from the database into a large language model and causing the large language model to output a response, and a storage process of vectorizing a conversation history including the target user input and the output response and storing the vectorized conversation history in the database.

According to the present disclosure, it is possible to reduce the number of tokens input to a large language model while suppressing performance degradation.

### BRIEF DESCRIPTION OF DRAWINGS

FIG. 1 is a block diagram illustrating a configuration example of one example embodiment of the dialogue system according to the present disclosure.

FIG. 2 is a flowchart illustrating an operation example of the dialogue system.

FIG. 3 is an explanatory diagram illustrating a specific use case of the dialogue system.

FIG. 4 is a block diagram illustrating an overview of the dialogue system according to the present disclosure.

FIG. 5 is a schematic block diagram illustrating a configuration of a computer according to at least one example embodiment.

### DETAILED DESCRIPTION OF THE INVENTION

For example, as a method of limiting the number of tokens of the large language model within an upper limit when inputting history information, there may be considered a method of including conversations up to a past n times in the history information and not using conversations prior to that in the history, a method of summarizing the history information so as to have a specified number of tokens, or a combination thereof.

However, in the above-described methods, when the history becomes long, information necessary for the current dialogue may be missing. In addition, when accuracy is ensured as much as possible, as the history information becomes large, it is necessary to input a number of tokens that is always close to the upper limit of the target model.

In general, performance and usage fees of a large language model deteriorate in proportion to the number of tokens. As a result, even for a dialogue that can originally be derived with only a small amount of information in the history, performance degradation and an increase in usage amount may occur due to unnecessary quotation of history.

Accordingly, the present disclosure describes a method of reducing the number of input tokens by deriving only a history necessary for the current dialogue. Further, the present disclosure also describes a method of vectorizing and storing inputs and responses so as to enable derivation of the necessary history.

The dialogue system according to the present disclosure is a system that receives questions, inquiries, instructions, and the like from a user and provides responses corresponding to the inquiries. In the following description, content input by the user, specifically questions, inquiries, instructions, and the like, is referred to as a user input. Hereinafter, example embodiments of the present disclosure will be described with reference to the drawings.

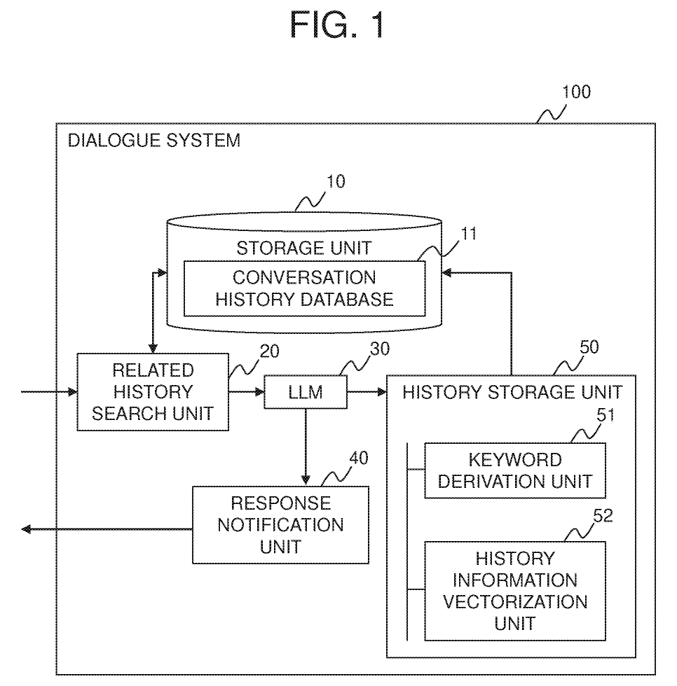

FIG. 1 is a block diagram illustrating a configuration example of one example embodiment of the dialogue system according to the present disclosure. A dialogue system 100 according to the present example embodiment includes a storage unit 10, a related history search unit 20, a large language model 30, a response notification unit 40, and a history storage unit 50. Arrows illustrated in FIG. 1 schematically indicate flows of data and do not exclude bidirectionality of data.

The storage unit 10 stores various types of information used for processing by the dialogue system 100. In the present example embodiment, the storage unit 10 includes a conversation history database 11 that stores a conversation history with the user. In the present example embodiment, the conversation history includes information including a user input and a response by the large language model 30.

The conversation history database 11 is a database that stores the conversation history in a vector format. The conversation history is stored in the conversation history database 11 by the history storage unit 50 described later. A method of vectorizing the conversation history is optional. The vector format stored in the conversation history database 11 may be determined in advance for the entire system. For example, the conversation history database 11 may store conversation histories vectorized by BERT (Bidirectional Encoder Representations from Transformers) or a Universal Sentence Encoder.

The conversation history database 11 may store, together with the conversation history, words serving as clues of the conversation, hereinafter referred to as keywords, in association with the conversation history. By storing such information, the related history search unit 20 described later can search for a conversation history having a higher degree of relevance to the user input.

The large language model 30 is a model that outputs a response to a user input and past conversation histories as inputs. A mode of the large language model 30 used in the dialogue system 100 according to the present example embodiment is optional. For example, a general-purpose generative artificial intelligence may be used, or a dialogue-type artificial intelligence specialized to enable natural conversation may be used.

The related history search unit 20 receives a user input. A method by which the related history search unit 20 receives the user input is optional, and may be text input or voice input. When voice input is provided, the related history search unit 20 converts the input voice into text and uses the user input converted into text. Then, the related history search unit 20 performs a vector search, from the conversation history database 11, for a conversation history related to the user input, which is hereinafter referred to as a related history.

As an algorithm or method for the vector search, any method may be used. For example, the related history search unit 20 may perform the vector search using a distance metric such as cosine similarity or Euclidean distance and a neighborhood search algorithm such as approximate nearest neighbor. However, the vector search method is not limited to the above-described methods and may be determined according to desired search speed and search accuracy.

The vector search method may be determined in advance or may be specified by the user. When receiving an instruction of the vector search method from the user, the related history search unit 20 may perform the vector search in accordance with the received instruction.

Then, the related history search unit 20 inputs the user input and the related history retrieved from the conversation history database 11 into the large language model 30 and causes the large language model 30 to output a response. The related history obtained by the vector search with respect to the user input can be said to be a conversation history related to the user input. Since the related history search unit 20 inputs, together with the user input, only conversation histories narrowed down to those related to the user input into the large language model 30, it is possible to reduce the number of tokens input to the large language model while suppressing degradation in response performance.

The response notification unit 40 notifies the user of the response by the large language model 30. For example, the response notification unit 40 may display the response on a display device not illustrated. Alternatively, the response notification unit 40 may convert the response into voice and output the voice from a speaker not illustrated.

The history storage unit 50 stores, in the conversation history database 11, a conversation history including the user input and the response output by the large language model 30 to the user input. The history storage unit 50 includes a keyword derivation unit 51 and a history information vectorization unit 52.

The keyword derivation unit 51 derives keywords serving as clues of the conversation history. A method by which the keyword derivation unit 51 derives keywords of the conversation history is optional. For example, the keyword derivation unit 51 may extract words from the conversation history by morphological analysis and identify important words as keywords by using term frequency-inverse document frequency.

Alternatively, the keyword derivation unit 51 may derive keywords using a pre-trained model that inputs a conversation history and outputs keywords of the conversation history. Specifically, the keyword derivation unit 51 may input the conversation history into the large language model 30 and cause the large language model 30 to output keywords of the conversation history. By using the large language model 30, it is possible to make processing of the system compact.

The history information vectorization unit 52 vectorizes the conversation history including the user input and the output response and stores the vectorized conversation history in the conversation history database 11. A vectorization method used by the history information vectorization unit 52 may be any method as long as the method can vectorize the conversation history in the same manner as the vector format stored in the conversation history database 11.

When keywords of the conversation history are derived by the keyword derivation unit 51, the history information vectorization unit 52 may vectorize the conversation history and the associated keywords and store them in the conversation history database 11.

When only the conversation history is stored in the conversation history database 11, the history storage unit 50 does not necessarily include the keyword derivation unit 51. However, since associating keywords with the conversation history and storing them is considered to improve search accuracy of the conversation history by the related history search unit 20, it is preferable that the history storage unit 50 includes the keyword derivation unit 51.

The related history search unit 20, the response notification unit 40, and the history storage unit 50, more specifically the keyword derivation unit 51 and the history information vectorization unit 52, are implemented by a processor of a computer that operates according to a program, such as a CPU or a GPU. For example, the program may be stored in the storage unit 10 of the dialogue system 100, and the processor may read the program and operate as the related history search unit 20, the response notification unit 40, and the history storage unit 50.

Functions of the dialogue system 100 may be provided in a software as a service format. Alternatively, the related history search unit 20, the response notification unit 40, and the history storage unit 50 may each be implemented by dedicated hardware.

Further, part or all of constituent elements of each device may be implemented by a general-purpose or dedicated circuit, a processor, or a combination thereof. These may be configured by a single chip or by a plurality of chips connected via a bus. Part or all of constituent elements of each device may be implemented by a combination of the above-described circuits and a program.

When part or all of constituent elements of the dialogue system 100 are implemented by a plurality of information processing devices or circuits, the plurality of information processing devices or circuits may be arranged in a centralized manner or in a distributed manner. For example, the information processing devices or circuits may be implemented in a form connected via a communication network, such as a client-server system or a cloud computing system.

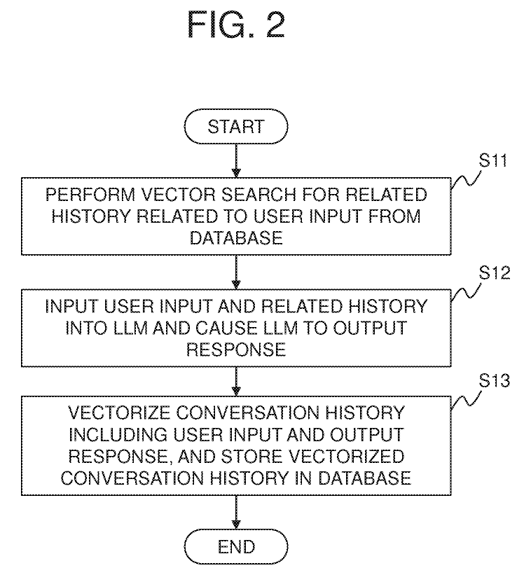

Next, an operation example of the dialogue system 100 according to the present example embodiment will be described. FIG. 2 is a flowchart illustrating an operation example of the dialogue system 100 according to the present example embodiment.

The related history search unit 20 performs a vector search, from the conversation history database 11, for a related history related to a target user input (step S11). The related history search unit 20 inputs the target user input and the related history retrieved from the conversation history database 11 into the large language model and causes the large language model to output a response (step S12). The history storage unit 50 vectorizes a conversation history including the target user input and the output response and stores the vectorized conversation history in the conversation history database 11 (step S13).

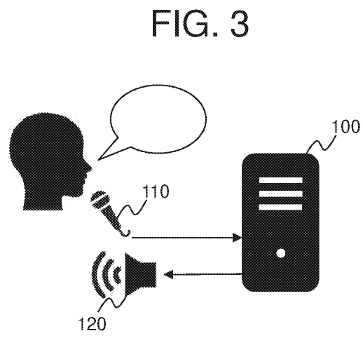

FIG. 3 is an explanatory diagram illustrating a specific use case of the dialogue system according to the present disclosure. The dialogue system 100 illustrated in FIG. 3 assumes a case in which dialogue continues for a long period and more conversation histories are accumulated. In this use case, an example is illustrated in which the user input is provided by voice input and the response is also output by voice. However, the user input may be provided as text using a keyboard or a touch panel, and the response may be output as text.

When the user inputs a question or an inquiry by voice to a microphone 110, the related history search unit 20 of the dialogue system 100 receives the user input by voice, converts the voice into text, and performs a vector search for a related history using the target user input converted into text. Then, the related history search unit 20 inputs the user input and the related history into the large language model 30 and causes the large language model 30 to output a response.

The response notification unit 40 converts the response by the large language model 30 into voice and outputs the voice from a speaker 120. On the other hand, the history storage unit 50 stores, in the conversation history database 11, a conversation history vectorized from the user input and the response.

As described above, in the present example embodiment, the related history search unit 20 performs a vector search, from the conversation history database 11, for a related history related to a target user input, inputs the target user input and the retrieved related history into the large language model 30, and causes the large language model 30 to output a response. Then, the history storage unit 50 vectorizes a conversation history including the target user input and the output response and stores the vectorized conversation history in the conversation history database 11. Accordingly, it is possible to reduce the number of tokens input to the large language model while suppressing performance degradation.

That is, in the present disclosure, in a dialogue that requires inputting a long history into the large language model 30, the related history search unit 20 inputs only a highly relevant history. Therefore, a reduction in the number of tokens input to the large language model 30 is expected. In addition, since the number of input tokens is reduced, an improvement in response speed and a reduction in usage fees are also expected.

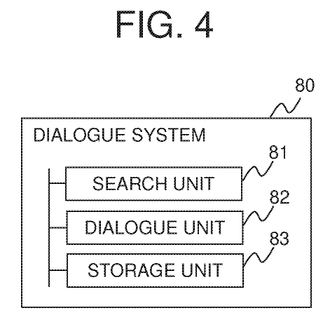

Next, an overview of the present disclosure will be described. FIG. 4 is a block diagram illustrating an overview of the dialogue system according to the present disclosure. A dialogue system 80 (for example, the dialogue system 100) according to the present disclosure includes a search unit 81 (for example, the related history search unit 20) that performs a vector search, from a database (for example, the conversation history database 11) that stores a conversation history including a user input (for example, questions, inquiries, instructions, and the like by a user) and a response to the user input, for a related history that is the conversation history related to a target user input, a dialogue unit 82 (for example, the related history search unit 20) that inputs the target user input and the related history retrieved from the database into a large language model (for example, the large language model 30) and causes the large language model to output a response, and a storage unit 83 (for example, the history storage unit 50) that vectorizes a conversation history including the target user input and the output response and stores the vectorized conversation history in the database.

With such a configuration, it is possible to reduce the number of tokens input to the large language model while suppressing performance degradation.

The dialogue system 80 may further include a keyword derivation unit (for example, the keyword derivation unit 51) that derives keywords serving as a clue of the conversation history. The storage unit 83 may vectorize the conversation history and the associated keywords and store the vectorized conversation history and the associated keyword in the database.

Specifically, the keyword derivation unit may input the conversation history into the large language model (for example, the large language model 30) and cause the large language model to output keywords of the conversation history.

The search unit 81 may perform the vector search using a neighborhood search algorithm.

The search unit 81 may convert a user input provided by voice into text and perform the vector search for the related history using the user input converted into text.

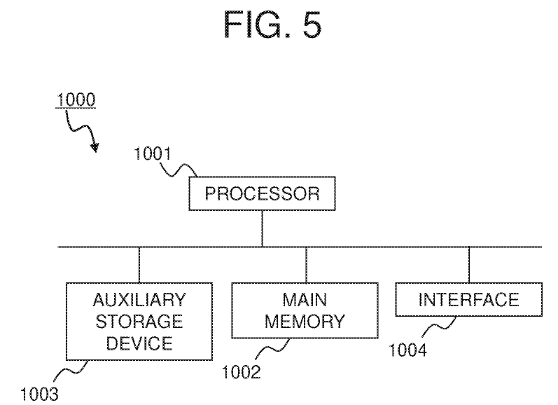

FIG. 5 is a schematic block diagram illustrating a configuration of a computer according to at least one example embodiment. A computer 1000 includes a processor 1001, a main memory 1002, an auxiliary storage device 1003, and an interface 1004. The computer 1000 may be connected to a computer that executes a mathematical programming solver, an annealing machine, a simulator, or the like.

The above-described dialogue system 80 is implemented in the computer 1000. Operations of the above-described processing units are stored in the auxiliary storage device 1003 in a form of a program, which is a dialogue program. The processor 1001 reads the program from the auxiliary storage device 1003, expands the program into the main memory 1002, and executes the above-described processing according to the program.

In at least one example embodiment, the auxiliary storage device 1003 is an example of a non-transitory tangible medium. Other examples of the non-transitory tangible medium include a magnetic disk, a magneto-optical disk, a CD-ROM, a DVD-ROM, and a semiconductor memory connected via the interface 1004. When the program is distributed to the computer 1000 via a communication line, the computer 1000 that receives the distribution may expand the program into the main memory 1002 and execute the above-described processing.

The program may be for implementing part of the above-described functions. Further, the program may be a so-called difference file that implements the above-described functions in combination with another program already stored in the auxiliary storage device 1003.

Although the present disclosure has been described with reference to the example embodiments and examples, the present disclosure is not limited to the above-described example embodiments and examples. Various modifications that can be understood by those skilled in the art can be made to the configuration and details of the present disclosure within the scope of the present disclosure.

1. A dialogue system comprising:
a memory storing instructions; and
one or more processors configured to execute the instructions to:
perform a vector search, from a database that stores a conversation history including a user input and a response to the user input, for a related history that is the conversation history related to a target user input;
input the target user input and the related history retrieved from the database into a large language model and cause the large language model to output a response; and
vectorize a conversation history including the target user input and the output response and store the vectorized conversation history in the database.

2. The dialogue system according to claim 1, wherein the processor is configured to execute the instructions to:
derive a keyword serving as a clue of the conversation history; and
vectorize the conversation history and the associated keyword and store the vectorized conversation history and the associated keyword in the database.

3. The dialogue system according to claim 2, wherein the processor is configured to execute the instructions to input the conversation history into the large language model and cause the large language model to output the keyword of the conversation history.

4. The dialogue system according to claim 1, wherein the processor is configured to execute the instructions to perform the vector search using a neighborhood search algorithm.

5. The dialogue system according to claim 1, wherein the processor is configured to execute the instructions to convert a user input provided by voice into text and perform the vector search for the related history using the user input converted into text.

6. A dialogue method comprising:
performing a vector search, from a database that stores a conversation history including a user input and a response to the user input, for a related history that is the conversation history related to a target user input;
inputting the target user input and the related history retrieved from the database into a large language model and causing the large language model to output a response; and
vectorizing a conversation history including the target user input and the output response and storing the vectorized conversation history in the database.

7. The dialogue method according to claim 6, comprising:
deriving a keyword serving as a clue of the conversation history; and
vectorizing the conversation history and the associated keyword and storing the vectorized conversation history and the associated keyword in the database.

8. A non-transitory computer readable information recording medium storing a dialogue program, when executed by a processor, that performs a method for:
performing a vector search, from a database that stores a conversation history including a user input and a response to the user input, for a related history that is the conversation history related to a target user input;
inputting the target user input and the related history retrieved from the database into a large language model and causing the large language model to output a response; and
vectorizing a conversation history including the target user input and the output response and storing the vectorized conversation history in the database.

9. The non-transitory computer readable information recording medium according to claim 8, wherein the dialogue program performs a method for:
deriving a keyword serving as a clue of the conversation history; and
vectorizing the conversation history and the associated keyword and storing the vectorized conversation history and the associated keyword in the database.
